(19) United States
(12) Patent Application Publication
(10) Pub. No.: US 2021/0251189 A1
(43) Pub. Date: Aug. 19, 2021

(54) PET TOY

(71) Applicants: Margaret Wong, Petaluma, CA (US); Lisa Davis, Fairfax, CA (US); Aimee Diskin, Napa, CA (US); Shiyu Guo, San Rafael, CA (US); Hannah Rosenberg, San Francisco, CA (US); Michael Risso, Napa, CA (US)

(72) Inventors: Margaret Wong, Petaluma, CA (US); Lisa Davis, Fairfax, CA (US); Aimee Diskin, Napa, CA (US); Shiyu Guo, San Rafael, CA (US); Hannah Rosenberg, San Francisco, CA (US); Michael Risso, Napa, CA (US)

(73) Assignee: Worldwise, Inc., Novato, CA (US)

(21) Appl. No.: 16/791,772

(22) Filed: Feb. 14, 2020

(51) Int. Cl. A01K 15/02

(52) U.S. Cl. CPC A01K 15/025

(57) ABSTRACT

A pet toy having a body configured in a shape that is attractive to a cat and a consumer. The pet toy is in the form of a pet toy body, the pet toy body having a cavity, the cavity having a smooth surface and diameter. A rigid insert having a smooth surface and a coefficient of friction less than that of the pet toy body and diameter equal to the diameter of the cavity. The cavity is sized such that a retained portion of the rigid insert is captured within the cavity and a portion of the rigid sphere extends outside of said spherical cavity such that during play, a portion of the rigid insert is in contact with a support surface for the pet toy.

### TECHNICAL FIELD

The present invention involves a cat attraction toy capable of amusing and occupying a domestic cat for extended periods of time and without the need for significant human intervention.

### BACKGROUND OF THE INVENTION

It is well-known that pet cats require stimulation. Without it, they get bored which could result in health problems and associated unwelcome anti-social behavior. It is also well known to anyone owning a pet cat that they express a natural instinct to be almost mesmerized by moving objects. This stems from their instinctual need to chase prey. When a pet cat swats at an inanimate object which then moves in response, this only stimulates the cat to interact more aggressively with it causing it to swat and pounce upon the toy as a consequence.

To achieve commercial success, cat attractants must be robust enough to withstand the rigors of active play, be self-contained so that intervention by the pet owner is not necessary and be sufficiently stimulating to avoid boredom. Prior pet toys which are currently available succeed in some of these goals but not all and those that do tend to be overly complex and thus expensive and prone to breakage.

Is thus an object of the present invention to provide a pet toy which is robust and is capable of withstanding the rigors of active play.

It is a further object of the present invention to provide a pet toy which is self-contained so that intervention by the pet owner is not necessary.

It is still a further object of the present invention to provide a pet toy which is capable of stimulating a pet cat for an extended period of time without the need for complex electromechanical components or parts.

These and further objects be more readily apparent when considering the following disclosure and appended claims.

### SUMMARY OF THE INVENTION

A method of entertaining a cat and stimulating its hunt and pray instincts comprising placing a pet toy in the vicinity of the cat, the pet toy having a pet toy body, the pet toy body having a cavity, the cavity having a smooth surface. A rigid insert is provided having a smooth surface and coefficient of friction less than that of the pet toy body and a size substantially equal to that of the cavity. The cavity is sized such that a retained portion of the rigid insert is captured within it and a portion of the rigid insert extends outside of the cavity such that during play, a portion of the rigid insert is in contact with a support surface for the pet toy.

### BRIEF DESCRIPTION OF THE DRAWINGS

FIG. 1 is a perspective view of the pet toy the present invention.

FIG. 2 is a side view of the pet toy the present invention.

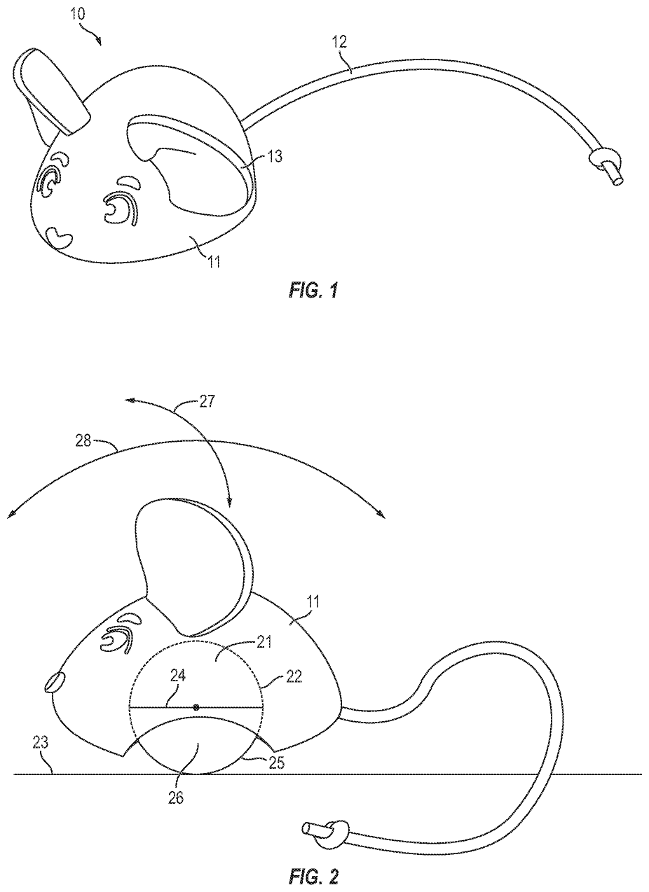

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

In turning to the figures, pet toy 10 is shown configured in the shape of a rodent, such as a mouse, by providing pet toy body 11 composed of plastic or hard rubber sufficient to withstand anticipated vigorous play by a pet cat. It is noted however that other shapes can also be used while remaining within the spirit and scope of the present invention.

Pet toy body 11 is characterized as having a cavity 21 (FIG. 2) having smooth surface 22. Preferably, the cavity 21 is spherical although other shapes such as ovals and cylinders are contemplated. A rigid insert 26 is frictionally fit within cavity 21 as the size of rigid insert 26 is approximately equal to size of cavity 21. Specifically if cavity 21 was spherical and insert 26 was spherical, they would have the same diameter 24.

As noted in reference to FIG. 2, rigid insert 26 is partially captured by cavity 21 and part of rigid insert 26 extends outside and below pet body 11. Rigid insert 26 is preferably composed of a sphere or oval having a smooth surface such that its coefficient of friction is less than that of the pet toy body. Ideally, rigid insert 26 is preferably composed of steel thus being heavier and denser than pet toy body 11 urging pet toy 10 to remain upright during vigorous play although other materials such as hard, dense plastics can also be employed as long as the rigid insert is denser and having a lower coefficient of friction than pet body 11. Importantly, during use, relatively smooth surface 25 of rigid insert 26 is in contact with support surface 23 such as the flooring of the pet owner's home. As a cat engages pet toy 10, the pet toy scoots along surface 23 and encourages pet toy body 11 to rock in the direction of arrows 27 and 28. This rocking motion coupled with the low friction contact between relatively smooth surface 25 of rigid insert 26 and support surface 23 creates an erratic motion which triggers a pet cat's hunt and pounce instincts.

This further causes cord 12 replicating the tail of the rodent to move erratically further resulting in the pet's involvement with the toy.

In summary, pet toy 10 creates an engageable toy which plays upon a cat's hunt and pounce instincts, is relatively immune to breakage and requires no motors, batteries or other complex parts in accomplishing its sought after results.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A method of entertaining a cat and stimulating its hunt and pray instincts comprising placing a pet toy in the vicinity of the cat, said pet toy comprising a pet toy body having a cavity, the cavity having a smooth surface;
a rigid insert having a smooth surface and coefficient of friction less than that of the pet toy body and being sized to frictionally fit within and be retained by said cavity, a portion of said rigid insert extending outside of cavity such that during play, a portion of said rigid insert is in contact with a support surface for the pet toy.

2. The method of claim 1 wherein said cavity is substantially spherical.

3. The method of claim 2 wherein said rigid insert is substantially spherical.

4. The method of claim 1 wherein said rigid insert is heavier than said pet toy body to encourage said pet toy to remain upright during rigorous play.

5. The method of claim 4 wherein said rigid insert is comprised of steel.

6. The pet toy of claim 1 further comprising a cord extending from said pet toy body.
